(19) United States
(12) Patent Application Publication
(10) Pub. No.: US 2023/0028000 A1
(43) Pub. Date: Jan. 26, 2023

(54) METHOD AND APPARATUS OF INTERLACE BASED SIDELINK RESOURCE POOL

(71) Applicant: Samsung Electronics Co., Ltd., Suwon-si (KR)

(72) Inventors: Hongbo Si, Plano, TX (US); Emad N. Farag, Flanders, NJ (US)

(21) Appl. No.: 17/810,265

(22) Filed: Jun. 30, 2022

Related U.S. Application Data
(60) Provisional application No. 63/223,864, filed on Jul. 20, 2021.
(60) Provisional application No. 63/336,133, filed on Apr. 28, 2022.

(51) Int. Cl. H04W 72/02; H04W 72/04; H04L 27/26

(52) U.S. Cl. CPC H04W 72/02; H04W 72/0453; H04W 72/0446; H04L 27/26025; H04L 27/2605

(57) ABSTRACT

Methods and apparatuses for an interlace based resource pool sidelink (SL) in a wireless communication system. A method of a user equipment (UE) includes receiving a set of configurations and determining, from the set of configurations, a resource pool including a set of sub-channels. A sub-channel in the set of sub-channels includes a set of interlaces of resource blocks (RBs). An interlace in the set of interlaces includes RBs with a uniform interval of M RBs. The method further includes determining a set of resources within the resource pool allocated for a physical sidelink control channel (PSCCH) or a physical sidelink feedback channel (PSFCH) and transmitting, to another UE, the PSCCH or PSFCH based on the determined set of resources.

### CROSS-REFERENCE TO RELATED APPLICATIONS AND CLAIM OF PRIORITY

The present application claims priority to U.S. Provisional Patent Application No. 63/223,864, filed on Jul. 20, 2021, and U.S. Provisional Patent Application No. 63/336,133, filed on Apr. 28, 2022. The content of the above-identified patent document is incorporated herein by reference.

### TECHNICAL FIELD

The present disclosure relates generally to wireless communication systems and, more specifically, the present disclosure relates to an interlace based resource pool sidelink (SL) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an interlace based resource pool SL in a wireless communication system.

In one embodiment, a user equipment (UE) in a wireless communication system is provided. The UE includes a transceiver configured to receive a set of configurations and a processor operably coupled to the transceiver. The processor is configured to determine, from the set of configurations, a resource pool including a set of sub-channels and determine a set of resources within the resource pool allocated for a physical sidelink control channel (PSCCH) or a physical sidelink feedback channel (PSFCH). A sub-channel in the set of sub-channels includes a set of interlaces of resource blocks (RBs). An interlace in the set of interlaces includes RBs with a uniform interval of M RBs. The transceiver is further configured to transmit, to another UE, the PSCCH or PSFCH based on the determined set of resources.

In another embodiment, a method of a UE in a wireless communication system is provided. The method includes receiving a set of configurations and determining, from the set of configurations, a resource pool including a set of sub-channels. A sub-channel in the set of sub-channels includes a set of interlaces of RBs. An interlace in the set of interlaces includes RBs with a uniform interval of M RBs. The method further includes determining a set of resources within the resource pool allocated for a PSCCH or a PSFCH and transmitting, to another UE, the PSCCH or PSFCH based on the determined set of resources.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate an example of wireless transmit and receive paths according to various embodiments of the present disclosure;

FIG. 6 illustrates an example of resource pool in NR V2X according to various embodiments of the present disclosure;

FIG. 7 illustrates an example of slot structure for SL transmission and reception according to various embodiments of the present disclosure;

FIG. 8 illustrates an example of interlace of resource blocks within a BWP according to various embodiments of the present disclosure;

FIG. 9 illustrates an example of interlace of resource blocks according to various embodiments of the present disclosure;

FIG. 10 illustrates an example resource pool including interlace based sub-channels according to various embodiments of the present disclosure;

FIG. 11 illustrates an example of resource allocation for PSCCH according to various embodiments of the present disclosure;

FIG. 12 illustrates an example of resource allocation for PSFCH according to various embodiments of the present disclosure; and

FIG. 13 illustrates an example method for a UE determine an interlace based resource pool for SL communication according to embodiments of the present disclosure.

### DETAILED DESCRIPTION

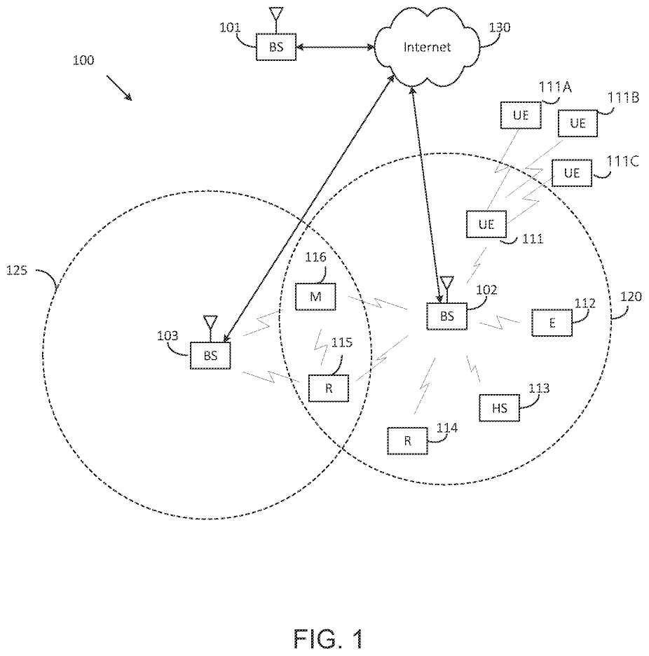

FIG. 1 through FIG. 13, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v.16.6.0, “Physical channels and modulation”; 3GPP TS 38.212 v.16.6.0, “Multiplexing and channel coding”; 3GPP TS 38.213 v16.6.0, “NR; Physical Layer Procedures for Control”; 3GPP TS 38.214: v.16.6.0, “Physical layer procedures for data”; 3GPP TS 38.321 v16.6.0, “Medium Access Control (MAC) protocol specification”; and 3GPP TS 38.331 v.16.5.0, “Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In various embodiments, a UE 116 may communicate with another UE 115 via a sidelink (SL). For example, both UEs 115-116 can be within network coverage (of the same or different base stations). In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an interlace based resource pool SL in a wireless communication system. In certain embodiments, and one or more of the gNBs 101-103 includes circuitry, programing, or a combination thereof, for an interlace based resource pool SL in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs (e.g., via a Uu interface or air interface, which is an interface between a UE and 5G radio access network (RAN)) and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UE 111A to 111C) that may have a SL communication with the UE 111, for example, for interlace based resource pool for SL communication. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

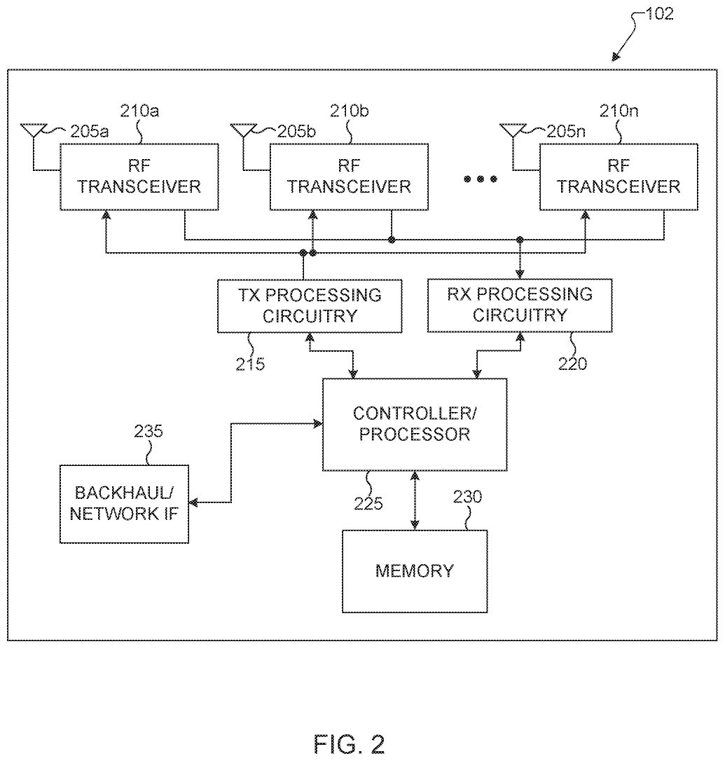

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this present disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink channel signals and the transmission of downlink channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support an interlace based resource pool SL in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

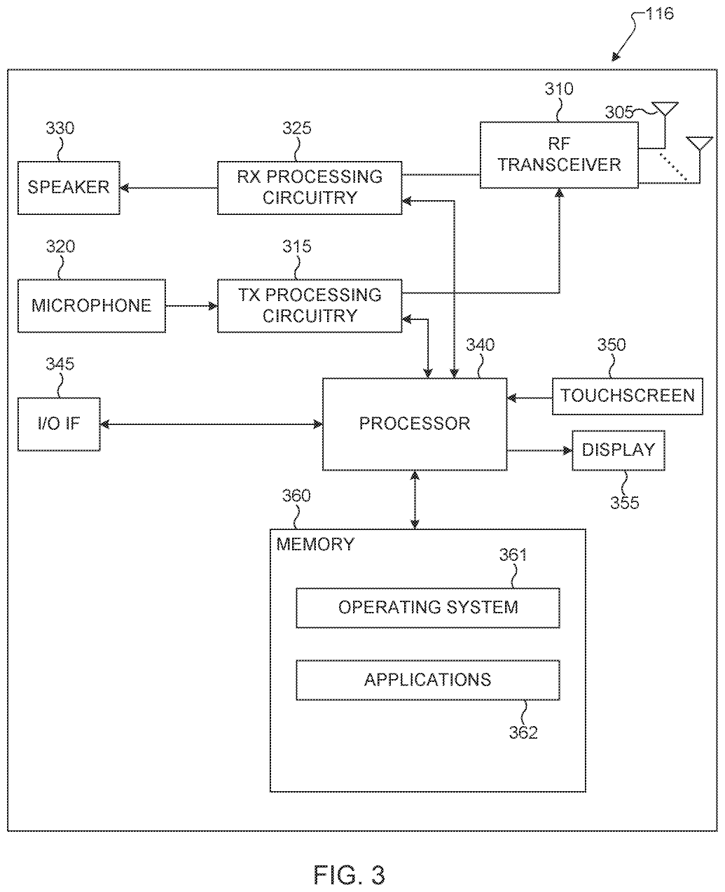

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this present disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100 or by other UEs (e.g., one or more of UEs 111-115) on a SL channel. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of downlink and/or sidelink channel signals and the transmission of uplink and/or sidelink channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for an interlace based resource pool SL in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points and a sidelink (SL) that refers to transmissions from one or more UEs to one or more UEs.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 30 KHz or 15 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DMRS is transmitted only in the BW of a respective PDCCH or PDSCH and a UE can use the DMRS to demodulate data or control information.

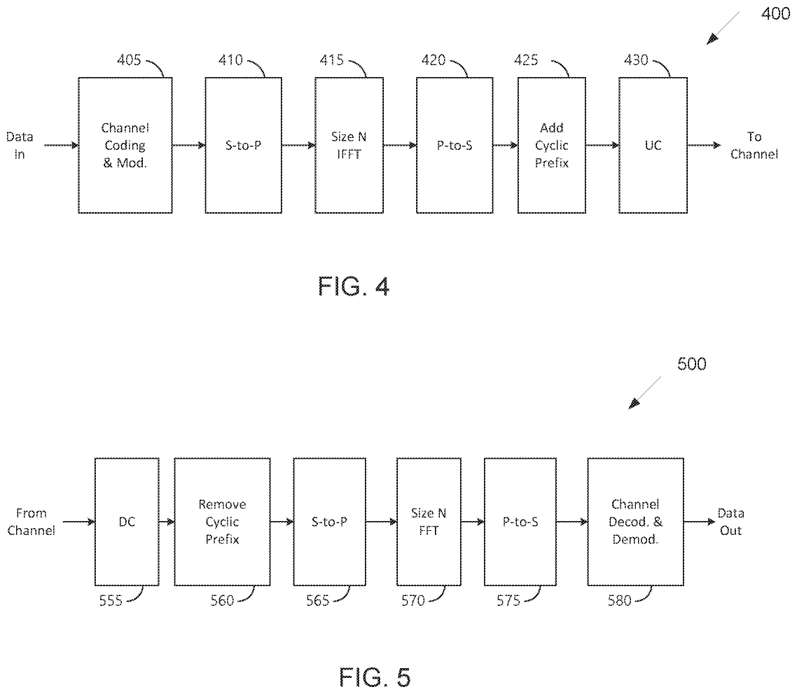

FIG. 4 and FIG. 5 illustrate example wireless transmit and receive paths according to this present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support SL communications. In some embodiments, the receive path 500 is configured to support SL measurements in vehicle-to-everything (V2X) communication as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sidelink to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

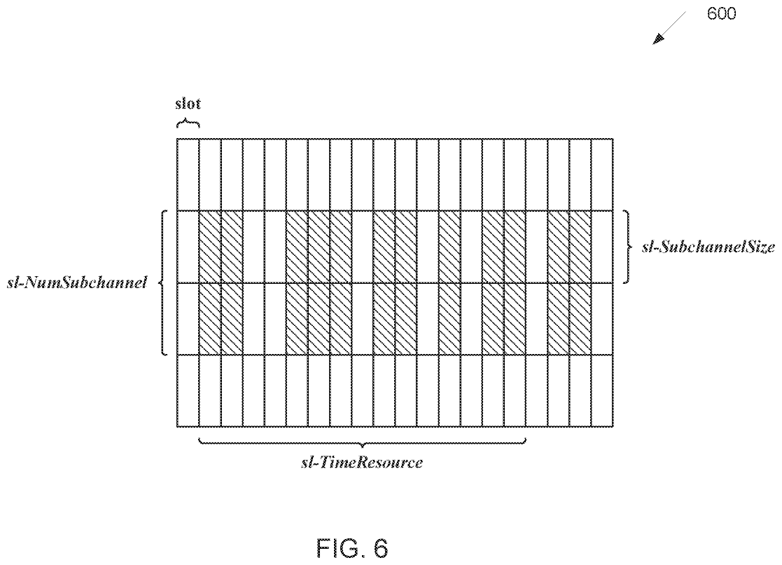

In Rel-16 NR V2X, transmission and reception of sidelink (SL) signals and channels are based on resource pool(s) confined in the configured SL bandwidth part (BWP). In the frequency domain, a resource pool consists of a (pre-)configured number (e.g., sl-NumSubchannel) of contiguous sub-channels, wherein each sub-channel consists of a set of contiguous resource blocks (RBs) in a slot with size (pre-)configured by higher layer parameter (e.g., sl-SubchannelSize). In time domain, slots in a resource pool occur with a periodicity of 10240 ms, and slots including S-SSB, non-UL slots, and reserved slots are not applicable for a resource pool. The set of slots for a resource pool is further determined within the remaining slots, based on a (pre-)configured bitmap (e.g., sl-TimeResource). An illustration of a resource pool is shown in FIG. 6.

FIG. 6 illustrates an example of resource pool in NR V2X 600 according to various embodiments of the present disclosure. An embodiment of the resource pool in NR V2X 600 shown in FIG. 6 is for illustration only.

FIG. 6 illustrates a resource pool in Rel-16 NR V2X. Transmission and reception of physical sidelink shared channel (PSSCH), physical sidelink control channel (PSCCH), and physical sidelink feedback channel (PSFCH) are confined within and associated with a resource pool, with parameters (pre-)configured by higher layers (e.g., SL-PSSCH-Config, SL-PSCCH-Config, and SL-PSFCH-Config, respectively).

A UE may transmit the PSSCH in consecutive symbols within a slot of the resource pool, and PSSCH resource allocation starts from the second symbol configured for sidelink, e.g., startSLsymbol+1, and the first symbol configured for sidelink is duplicated from the second configured for sidelink, for AGC purpose. The UE may not transmit PSCCH in symbols not configured for sidelink, or in symbols configured for PSFCH, or in the last symbol configured for sidelink, or in the symbol immediately preceding the PSFCH. The frequency domain resource allocation unit for PSSCH is the sub-channel, and the sub-channel assignment is determined using the corresponding field in the associated SCI.

For transmitting a PSCCH, the UE can be provided a number of symbols (either 2 symbols or 3 symbols) in a resource pool (e.g., sl-TimResourcePSCCH) starting from the second symbol configured for sidelink, e.g., startSLsymbol+1; and further provided a number of RBs in the resource pool (e.g., sl-FreqResourcePSCCH) starting from the lowest RB of the lowest sub-channel of the associated PSSCH.

The UE can be further provided a number of slots (e.g., sl-PSFCH-Period) in the resource pool for a period of PSFCH transmission occasion resources, and a slot in the resource pool is determined as containing a PSFCH transmission occasion if the relative slot index within the resource pool is an integer multiple of the period of PSFCH transmission occasion. PSFCH is transmitted in two contiguous symbols in a slot, wherein the second symbol is with index startSLsymbols+lengthSLsymbols−2, and the two symbols are repeated. In frequency domain, PSFCH is transmitted in a single RB, wherein OCC can be possibly applied within the RB for multiplexing, and the location of the RB is determined based on an indication of a bitmap (e.g., sl-PSFCH-RB-Set), and the selection of PSFCH resource is according to the source ID and destination ID.

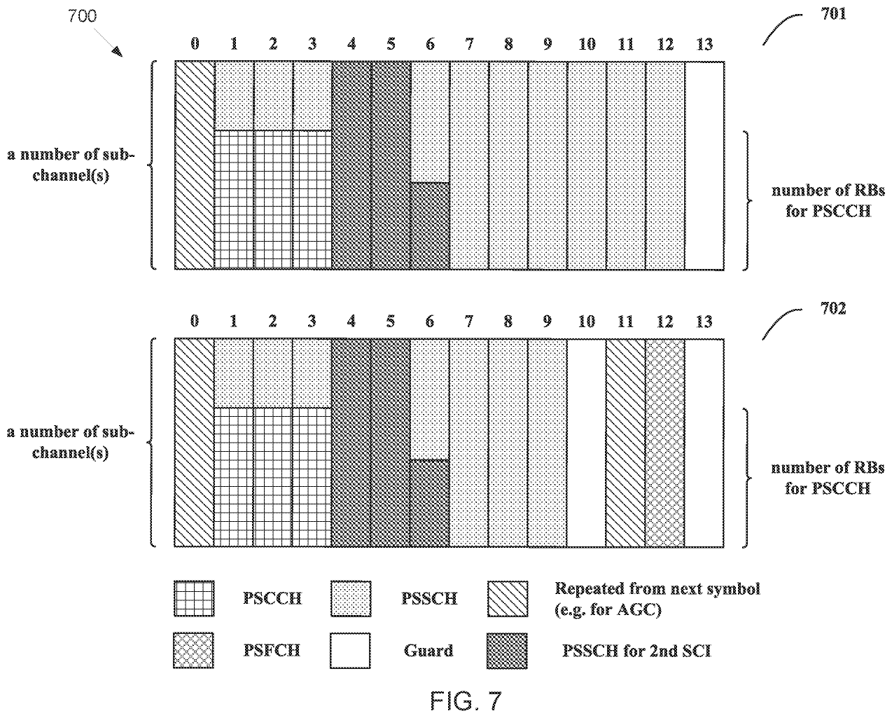

The first symbol including PSSCH and PSCCH is duplicated for AGC purpose. An illustration of the slot structure including PSSCH and PSCCH is shown in 701 of FIG. 7 and the slot structure including PSSCH, PSCCH and PSFCH is shown in 702 of FIG. 7.

FIG. 7 illustrates an example of slot structure for SL transmission and reception 700 according to various embodiments of the present disclosure. An embodiment of the slot structure for SL transmission and reception 700 shown in FIG. 7 is for illustration only.

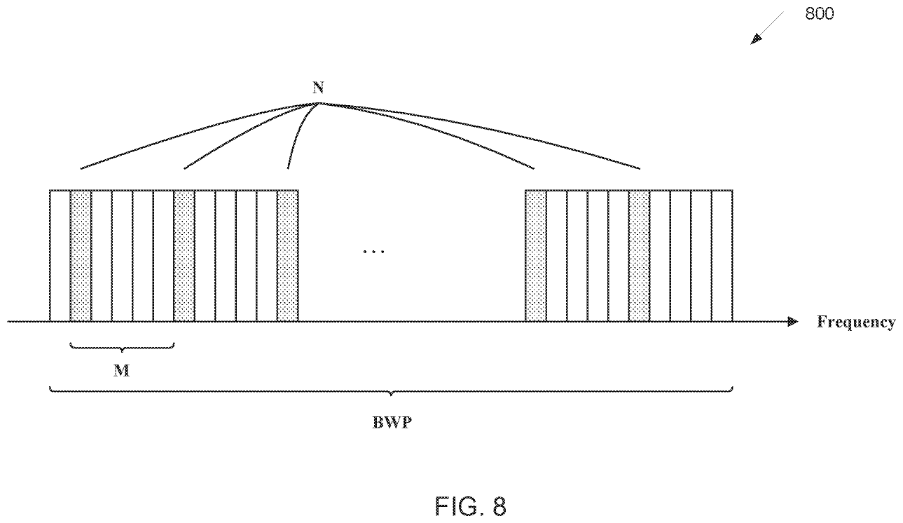

In Rel-16 NR unlicensed (NR-U) operation, in order to satisfy the occupied channel bandwidth (OCB) requirement and power spectral density (PSD) requirement according to the regulation of the unlicensed spectrum, an interlace based resource allocation for uplink channels, e.g., PUSCH and PUCCH, is supported. An interlace of resource blocks is defined as a set of uniformly distributed RBs with a fixed interval in the frequency domain, wherein the interval M can be determined based on a subcarrier spacing, for example M=10 for μ=0 and M=5 for μ=1, and there can be multiple interlaces of resource blocks (e.g., M interlaces) supported. For a nominal carrier bandwidth of 20 MHz (e.g., 5 GHz unlicensed or 6 GHz unlicensed spectrums), the number of resource blocks in an interlace (e.g., denoted as N) contained in a BWP configured for the carrier is 10 or 11, depending on the starting RB of the interlace within the BWP. An illustration of the interlace within a BWP is shown in FIG. 8.

FIG. 8 illustrates an example of interlace of resource blocks within a BWP 800 according to various embodiments of the present disclosure. An embodiment of the resource blocks within a BWP 800 shown in FIG. 8 is for illustration only.

Downlink control information (DCI) format 0_0 and 0_1 include information on “frequency domain resource assignment” to provide resource allocation for PUSCH in the frequency domain, and when interlace based resource allocation is configured, that information is interpreted differently from the case when interlace based resource allocation is not configured.

For one example, for μ=0, 6 most significant bits (MSBs) of the “frequency domain resource assignment” indicates the UE a set of allocated interlaces using a resource indication value (RIV), wherein the RIV corresponds to a starting interlace and the number of contiguous interlace indices when the RIV is smaller than M(M+1)/2, and corresponds to a starting interlace and a set of non-contiguous interlace indices based on a table when RIV is equal to or larger than M(M+1)/2. For another example, for μ=1, 5 most significant bits (MSBs) of the “frequency domain resource assignment” indicates the UE a set of allocated interlaces using a bitmap, wherein each of the bit in the bitmap corresponds to an interlace, and a bit taking the value of 1 indicates the corresponding interlace is allocated to the UE.

For PUCCH before RRC connection, only interlaced based PUCCH format 0 and 1 are applicable, and one interlace is assigned to the PUCCH with interlace index determined based on the RB offset configured in system information. For PUCCH after RRC connection, interlaced based PUCCH format 0, 1, 2, and 3 can be configured, wherein PUCCH format 0 and 1 can only be configured with a single interlace (e.g., interlace0), and PUCCH format 2 and 3 can be configured with at most two interlaces (e.g., interlace0 and interlace1).

For a sidelink operation on unlicensed spectrum, there is a need to support interlace based resource allocation such that the OCB and PSD requirement can be satisfied according to the regulation of the unlicensed spectrum. In particular, there is a need to support interlace based resource pool on sidelink, and the associated resource allocation for PSSCH, PSCCH, and PSFCH within the resource pool.

The present disclosure focuses on the design aspects of interlace based resource pool, including the interlace based sub-channel to construct the resource pool, the resource allocation of PSSCH, PSCCH, and PSFCH within the interlace based resource pool, and the associated signaling for the enabling the interlace based resource allocation and the corresponding indication of frequency domain resources when the interlace based resource allocation is enabled.

The present disclosure focuses on the interlace based sub-channel and resource pool, and the associated resource allocation for sidelink channels, wherein the following aspects are included: (1) interlace based sub-channel; (2) interlace based resource pool; (3) indication of the enabling of interlace based resource pool; (4) interlace based resource allocation for PSSCH; (5) interlace based resource allocation for PSCCH; and/or (6) interlace based resource allocation for PSFCH.

In one embodiment, an interlace can correspond to a set of resource blocks with a uniform interval between the start of neighboring two resource blocks in the frequency domain. The uniform interval can be denoted as M (e.g. in a unit of resource block), and a number of resource blocks within an interlace can be denoted as N. A sidelink sub-channel can be defined based on the interlace, wherein one sub-channel can include a number L of interlaces, and the set of resource blocks with respect to the number of interlaces are all confined in the SL BWP.

In one example, M is fixed, possibly determined based on the subcarrier spacing (SCS) of the BWP (e.g. the SCS of the RBs in the interlace is same as the SCS of the BWP). For one instance, M=10 for μ=0. For another instance, M=5 for μ=1. For yet another instance, M=2 for μ=2. For yet another instance, M=3 for μ=2.

In another example, M can be pre-configured or configured by the higher layer parameter, e.g., possibly associated with the (pre-)configuration of the resource pool. For instance, M can be (pre-)configured from a set of pre-defined values, e.g., from the set {2, 3, 5, 10, 20} or its subset.

In one example, N can be the same across interlaces within a BWP, and RB(s) other than the M·N RBs within the interlaces in the BWP are not assumed to be utilized for sidelink transmission or reception by the UE. For one instance, N=└N_{RB}^{BWP}/M┘, wherein N_{RB}^{BWP} is the number of RBs in the BWP. For instance, for a nominal bandwidth of 20 MHz (e.g., 5 GHz unlicensed spectrum or 6 GHz unlicensed spectrum), a UE may assume N is fixed as 10.

In another example, N can be different for interlaces in the BWP, and its value is determined based on the starting RB of the interlace in the BWP. In one further consideration for this example, any RB in the BWP can be utilized for transmission or reception by the UE. For one instance, N=┌N_{RB}^{BWP}/M┐ for the first interlace in the BWP, and N=└N_{RB}^{BWP}/M┘ for the last interlace in the BWP, wherein N_{RB}^{BWP} is the number of RBs in the BWP.

In yet another example, there can be a minimum value of N for any BWP in a carrier on the unlicensed spectrum. For instance, for a nominal bandwidth of 20 MHz (e.g., 5 GHz unlicensed spectrum or 6 GHz unlicensed spectrum), a UE may assume N is at least 10 (e.g., N is 10 or 11), e.g., for any BWP configured within a carrier with the nominal bandwidth.

In one example, the frequency location of an interlace can be determined by an interlace index m, where 0≤m<M.

In one example, one interlace based sub-channel can include a single interlace, e.g., L=1, and the interlace index can uniquely define the sub-channel, and e.g., the sub-channel index is the same as the interlace index. For this example, it is equivalent to not defining a sub-channel and using interlace to refer to a sub-channel.

In another example, one interlace based sub-channel can include one or multiple interlaces, e.g., L≥1, and if one interlace based sub-channel includes multiple interlaces, the multiple interlaces have contiguous interlace indices (e.g., subject to or not subject to a wraparound operation with respect to M). For this example, L can be pre-configured or configured by higher layer parameter, possibly associated with the (pre-)configuration of the resource pool. For instance, L can be (pre-)configured from a set of pre-defined values, e.g., from the set {1, 2, 5, 10} or its subset. For another instance, the sub-channel can be determined based on a starting interlace index and the number of contiguous interlace indices L.

In yet another example, one sub-channel can include one or multiple interlaces, e.g., L≥1, and if one interlace based sub-channel includes multiple interlaces, the multiple interlaces may or may not have contiguous interlace indices (e.g., subject to or not subject to a wraparound operation with respect to M). For this example, L can be pre-configured or configured by higher layer parameter, possibly associated with the (pre-)configuration of the resource pool. For one instance, the L interlaces in a sub-channel can be provided by a bitmap, wherein each bit in the bitmap corresponds to an interlace, and the number of bits taking value of 1 in the bitmap equals to L.

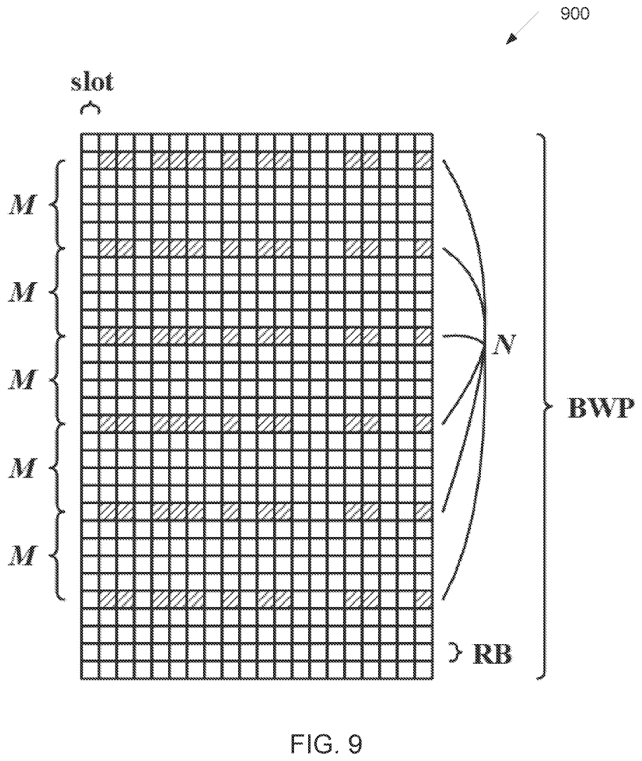

An illustration of the interlace of resource blocks is shown in FIG. 9.

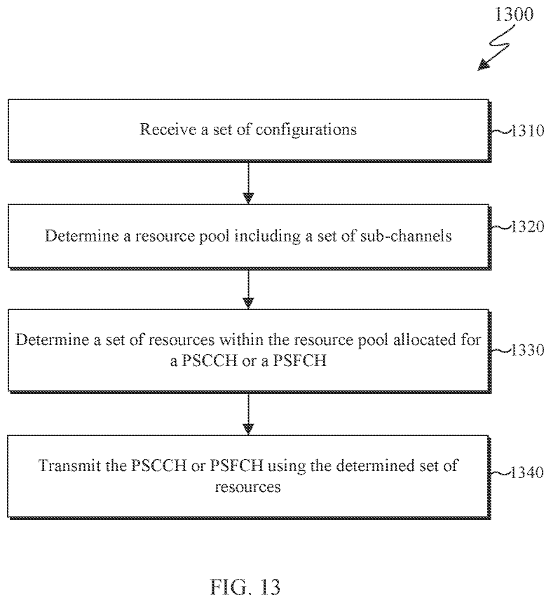

FIG. 9 illustrates an example of interlace of resource blocks 900 according to various embodiments of the present disclosure. An embodiment of the interlace of resource blocks 900 shown in FIG. 13 is for illustration only.

In one embodiment, a resource pool can be (pre-)configured as a number of interlace based sub-channel(s) in the frequency domain. Each sub-channel in the resource pool can have a relative sub-channel index, e.g., starting from 0.

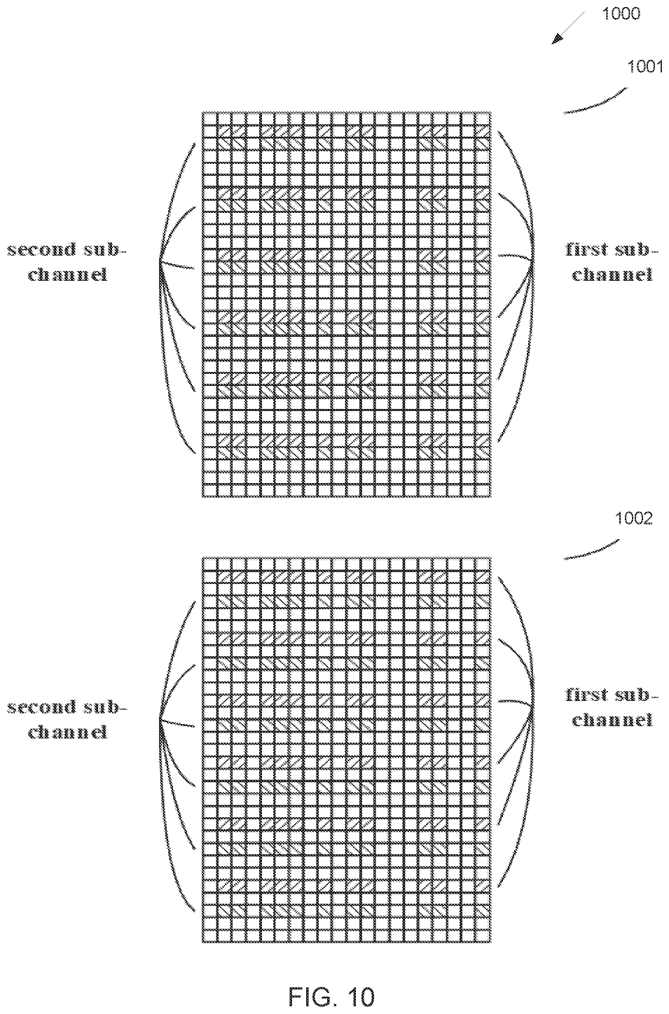

In one example, the interlace based sub-channels in the resource pool correspond to a set of consecutive interlace indices or consecutive sub-channel indices (e.g., with or without a wraparound operation with respect to M). For this example, the frequency domain information of the resource pool can be determined based on a starting sub-channel index (e.g., defined based on an interlace index) and a number of contiguous sub-channel(s), wherein, for one instance, the starting sub-channel index and a number of contiguous sub-channel(s) are pre-configured and/or provided by higher layer parameters, or for another instance, the startling sub-channel index and a number of contiguous sub-channel(s) are jointly coded by a RIV and pre-configured and/or provided by higher layer parameter, possibly associated with the (pre-)configuration of the resource pool. An illustration of the resource pool consisting of sub-channels with contiguous interlace indices is shown in 1001 of FIG. 10.

In another example, the interlace based sub-channels in the resource pool can be determined based on a bitmap, wherein the bitmap can be provided by a pre-configuration and/or a higher layer parameter (possibly associated with the (pre-)configuration of the resource pool), and each bit in the bitmap corresponds to an interlace based sub-channel. For one instance, the length of the bitmap is given by ┌M/L┐, and in the case of L=1, the bitmap is with length M. For another instance, the i-th leftmost bit in the bitmap corresponds to the sub-channel i−1, and the bit taking a value of 1 indicates the corresponding interlace based sub-channel is included in the resource pool, and the bit taking a value of 0 indicates the corresponding interlace based sub-channel is not included in the resource pool. For yet another instance, the number of sub-channels contained in the resource pool (e.g., N_{subchannel}^{SL}) is given by the number of bits taking value of 1 in the bitmap. For yet another instance, there could be further restriction on the bitmap that the sub-channel(s) (or interlace(s)) determined from the bitmap to be include in the resource pool are contiguous. An illustration of resource pool consisting of sub-channels with contiguous interlace indices and non-contiguous interlace indices are shown in 1001 and 1002 of FIG. 10, respectively.

FIG. 10 illustrates an example of resource pool including interlace based sub-channels 1000 according to various embodiments of the present disclosure. An embodiment of the resource pool including interlace based sub-channels 1000 shown in FIG. 10 is for illustration only.

In yet another example, the selection of the interlace based sub-channels is based on a set of pre-determined patterns. For this example, the set of pre-determined patterns on the selection of interlaces can be described in a table, and an index of the table is pre-configured to the UE or configured to the UE by higher layer parameter (possibly associated with the (pre-)configuration of the resource pool).

In yet another example, the combination of at least two of above examples can be utilized at the same time. For instance, more than one example can be utilized, wherein each example corresponds to a subcarrier spacing value of the BWP. For another instance, more than one example can be utilized, wherein different examples correspond to different value range of RIV.

In one embodiment, there is an indication on whether resource allocation for sidelink signal(s) and/or channel(s) is based on interlace of resource blocks, e.g., whether the sub-channel and/or resource pool is based on interlace of resource blocks.

In one example, there is an indication on whether resource allocation for PSSCH is based on interlace of resource blocks, by a pre-configuration or a higher layer parameter (e.g., sl-uselnterlacePSSCH). For one instance, this pre-configuration or higher layer parameter can be associated with the configuration of the BWP. For another instance, this pre-configuration or higher layer parameter can be associated with the configuration of the resource pool.

In another example, there is an indication on whether resource allocation for PSCCH is based on interlace of resource blocks, by a pre-configuration or a higher layer parameter (e.g., sl-uselnterlacePSCCH). For one instance, this pre-configuration or higher layer parameter can be associated with the configuration of the BWP. For another instance, this pre-configuration or higher layer parameter can be associated with the configuration of the resource pool.

In yet another example, there is an indication on whether resource allocation for PSFCH is based on interlace of resource blocks, by a pre-configuration or a higher layer parameter (e.g., sl-uselnterlacePSFCH). For one instance, this pre-configuration or higher layer parameter can be associated with the configuration of the BWP. For another instance, this pre-configuration or higher layer parameter can be associated with the configuration of the resource pool.

In yet another example, there can be an indication on whether resource allocation for PSSCH and PSCCH is based on interlace of resource blocks, by a pre-configuration or a higher layer parameter (e.g., sl-uselnterlacePSSCH-PSCCH). For this example, the UE assumes PSSCH and PSCCH share the same resource allocation method, either both based on interlace or both not based on interlace. For one instance, this pre-configuration or higher layer parameter can be associated with the configuration of the BWP. For another instance, this pre-configuration or higher layer parameter can be associated with the configuration of the resource pool.

In yet another example, there can be an indication on whether resource allocation for PSSCH and PSFCH is based on interlace of resource blocks, by a pre-configuration or a higher layer parameter (e.g., sl-uselnterlacePSSCH-PSFCH). For this example, the UE assumes PSSCH and PSFCH share the same resource allocation method, either both based on interlace or both not based on interlace. For one instance, this pre-configuration or higher layer parameter can be associated with the configuration of the BWP. For another instance, this pre-configuration or higher layer parameter can be associated with the configuration of the resource pool.

In yet another example, there can be an indication on whether resource allocation for PSCCH and PSFCH is based on interlace of resource blocks, by a pre-configuration or a higher layer parameter (e.g., sl-uselnterlacePSCCH-PSFCH). For this example, the UE assumes PSCCH and PSFCH share the same resource allocation method, either both based on interlace or both not based on interlace. For one instance, this pre-configuration or higher layer parameter can be associated with the configuration of the BWP. For another instance, this pre-configuration or higher layer parameter can be associated with the configuration of the resource pool.

In yet another example, there can be an indication on whether resource allocation for sidelink transmission and/or reception in the resource pool (e.g., at least including PSSCH, PSCCH and PSFCH) is based on interlace of resource blocks, by a pre-configuration or a higher layer parameter (e.g., sl-uselnterlacePSSCH-PSCCH-PSFCH or sl-uselnterlace). For this example, the UE assumes sidelink transmissions and/or receptions in the resource pool (e.g., at least including PSSCH, PSCCH and PSFCH) share the same resource allocation method, either all based on interlace or all not based on interlace (e.g., contiguous RB based). For one instance, this pre-configuration or higher layer parameter can be associated with the configuration of the BWP. For another instance, this pre-configuration or higher layer parameter can be associated with the configuration of the resource pool.

In one example, the UE assumes the indication on whether interlace based resource allocation is utilized for sidelink (e.g., at least for one of PSSCH, PSCCH, or PSFCH) has the same value as the indication on whether interlace based resource allocation is utilized for PUSCH and PUCCH (e.g., uselnterlacePUCCH-PUSCH in BWP-UplinkCommon or uselnterlacePUCCH-PUSCH in BWP-UplinkDedicated). The UE does not expect to be (pre-)configured to enable interlace based resource allocation for sidelink transmission (e.g., at least for one of PSSCH, PSCCH, or PSFCH), if interlace based resource allocation for PUSCH and PUCCH is not enabled.

In one embodiment, a UE can determine the first resource for transmitting PSSCH based on the indication in a SCI format (e.g., SCI format 1-A). The UE assumes that the interlace(s) of resource blocks determined available for resource allocation for transmitting PSSCH are within the resource pool.

For one example, the sub-channel indices for the first resource for transmitting PSSCH can be determined by a starting sub-channel index and a number of contiguous sub-channel(s).

For one sub-example of the starting sub-channel index, the sub-channel indices can be determined as the index of the sub-channel that includes the lowest interlace index available in the BWP.

For another sub-example of the starting sub-channel index, the sub-channel indices can be determined as the index of the sub-channel, wherein the lowest RB of the lowest interlace in the sub-channel overlaps with the lowest RB of the BWP.

For yet another sub-example of the starting sub-channel index, the sub-channel indices can be indicated by information in the SCI format (e.g., SCI format 1-A). For one instance, the starting sub-channel index and the number of contiguous sub-channel(s) are jointly coded by a RIV. For another instance, the starting sub-channel index can be provided by the information in the SCI format directly. For yet another instance, the starting sub-channel index can be provided using a table, and the corresponding index of the table is provided by the information in the SCI format.

For one sub-example of the number of contiguous sub-channel(s), the number of contiguous sub-channel(s) can be fixed. For one instance, the number of contiguous sub-channel(s)can be fixed as 1.

For another sub-example of the number of contiguous sub-channel(s), the number of contiguous sub-channel(s) can be determined based on the number of contiguous sub-channel(s) for other resources for transmitting PSSCH, with the assumption that all the resources for transmitting PSSCH indicated by the same SCI format have the same number of contiguous sub-channel(s).

For yet another sub-example of the number of contiguous sub-channel(s), the number of contiguous sub-channel(s) can be indicated by information in the SCI format (e.g., SCI format 1-A). For one instance, the starting sub-channel index and the number of contiguous sub-channel(s) are jointly coded by a RIV. For another instance, the number of contiguous sub-channel(s) can be provided by the information in the SCI format directly. For yet another instance, the number of contiguous sub-channel(s) can be provided using a table, and the corresponding index of the table is provided by the information in the SCI format.

In another example, the sub-channel(s) for the first resource for transmitting PSSCH can be determined based on a bitmap, wherein the bitmap can be provided by a SCI format (e.g., SCI format 1-A), and each bit in the bitmap corresponds to a sub-channel. For one instance, the length of the bitmap is M, and the i-th leftmost bit in the bitmap corresponds to the interlace index i−1, and the bit taking a value of 1 indicates the corresponding interlace based sub-channel is available for resource allocation, and the bit taking a value of 0 indicates the corresponding interlace based sub-channel is not available for resource allocation. For another instance, the length of the bitmap is the number of sub-channels in the resource pool (e.g., N_{subchannel}^{SL}), and the i-th leftmost bit in the bitmap corresponds to the sub-channel i−1 (the relative index within the resource pool starting from 0), and the bit taking a value of 1 indicates the corresponding interlace based sub-channel is available for resource allocation, and the bit taking a value of 0 indicates the corresponding interlace based sub-channel is not available for resource allocation.

In yet another example, the combination of at least two of above examples and/or instances can be utilized at the same time. For instance, more than one example and/or instances can be utilized, wherein each corresponds to a subcarrier spacing value of the BWP. For another instance, more than one example and/or instances can be utilized, wherein different ones correspond to different value range of RIV.

In one embodiment, a UE can determine the other resources for transmitting PSSCH based on the indication in a SCI format (e.g., SCI format 1-A). The UE assumes that the interlace(s) determined available for resource allocation for transmitting PSSCH are within the resource pool.

In one example, for other resource(s) for transmitting PSSCH, the UE can assume the frequency domain information is the same as the first resource for transmitting PSSCH.

In another example, the UE can assume each resource of the other resource(s) for transmitting PSSCH can be determined by a starting sub-channel and a number of contiguous sub-channel(s), wherein the number of contiguous sub-channel(s) is the same as the number of contiguous sub-channel(s) for the first resource.

For one sub-example, when the maximum number of resources per reserve is 2 (e.g., sl-MaxNumPerReserve is 2), the starting sub-channel and a number of contiguous sub-channel(s) for the second resource can be jointly coded using a RIV given by: RIV=n_{subCH,1}^{start}+Σᵢ₌₁^{LsubCH-1}(N_{subchannel}^{SL}+1−i) wherein n_{subCH,1}^{start} is the sub-channel for the second resource, L_{subCH} is the number of contiguous sub-channel(s) for both the first and second resources, and N_{subchannel}^{SL} is the total number of sub-channel(s) within the resource pool. For this sub-example,

$$⌈ {log}_{2} ( \frac{{N}_{subChannel}^{SL} ( {N}_{subChannel}^{SL} + 1 )}{2} ) ⌉$$

bits are needed in the information of SCI format 1-A for frequency resource assignment.

For another sub-example, when the maximum number of resources per reserve is 3 (e.g., sl-MaxNumPerReserve is 3), the starting sub-channel and a number of contiguous sub-channel(s) for the second and third resource can be jointly coded using a RIV given by: RIV=n_{subCH,1}^{start}+n_{subCH,2}^{start}·(N_{subchannel}^{SL}+1−L_{subCH})+Σᵢ₌₁^{LsubCH-1}(N_{subchannel}^{SL}+1−i)² wherein n_{subCH,1}^{start} and n_{subCH,2}^{start} are the starting sub-channels for the second and third resource respectively, L_{subCH} is the number of contiguous sub-channel(s) for all the first, second, and third resources, and N_{subchannel}^{SL} is the total number of sub-channel(s) within the resource pool. For this sub-example,

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉$$

bits are needed in the information of SCI format 1-A for frequency resource assignment.

In yet another example, for each resource in the other resource(s) for transmitting PSSCH can be determined by a separate bitmap in the SCI format (e.g., SCI format 1-A). For one instance, the length of the bitmap is M, and the i-th leftmost bit in the bitmap corresponds to the interlace index i−1, and the bit taking a value of 1 indicates the corresponding interlace based sub-channel is available for resource allocation, and the bit taking a value of 0 indicates the corresponding interlace based sub-channel is not available for resource allocation. For another instance, the length of the bitmap is the number of sub-channels in the resource pool (e.g., N_{subchannel}^{SL}), and the i-th leftmost bit in the bitmap corresponds to the sub-channel i−1 (the relative index within the resource pool starting from 0), and the bit taking a value of 1 indicates the corresponding interlace based sub-channel is available for resource allocation, and the bit taking a value of 0 indicates the corresponding interlace based sub-channel is not available for resource allocation.

In one embodiment, a DCI format 3_0 includes the same information on frequency resource assignment as in a SCI format 1-A.

In one embodiment, the determination of the frequency domain resources for transmitting and/or receive SL signal/channel can be based on a wideband operation, e.g., the wideband is provided by the indicated set of RB sets. For example, the indication for wideband includes a set of number of RBs in each channel (e.g., LBT bandwidth) and a set of number of RBs between neighboring channels as guard bands. For one further consideration, the indication can be provided by a pre-configuration and/or configured by higher layer parameter.

For one example, when an interlace based resource pool includes multiple channels (e.g., LBT bandwidth), a sub-channel in the interlace based resource pool can correspond to the set of RBs in an interlace confined within a channel. For one further consideration, this example is applicable when the RB sets are indicated.

For another example, when an interlace based resource pool includes multiple channels (e.g., LBT bandwidth), a sub-channel in the interlace based resource pool can correspond to the set of RBs in an interlace within all channels. For one further consideration, this example is applicable when the RB sets are not indicated.

For one example, if a UE is indicated a set of sub-channels including interlaces of resource blocks for SL transmission and/or reception, and the UE is also indicated a set of RB sets for SL transmission and/or reception, the UE can determine the resource allocation in frequency domain as an intersection of the interlaces of resource blocks in the indicated set of sub-channels and the union of the indicated set of RB sets and intra-cell guard bands between the indicated RB sets.

For another example, if a UE is indicated a set of interlaces of resource blocks for SL transmission and/or reception, and not indicated with a set of RB sets for SL transmission and/or reception, the UE can determine the resource allocation in frequency domain as an intersection of the interlaces of resource blocks in the indicated set of sub-channels and a single RB set of the active SL BWP. For one instance, the single RB set can be the lowest indexed one amongst all the RB sets that intersects the lowest RB of PSCCH. For another instance, the single RB set can be the RB set with index 0 in the active BWP, e.g., when there is no intersection between the RB sets and the lowest RB of PSCCH.

In one embodiment, the resource allocation for PSCCH can be based on interlaced based resource pool. For instance, the resource allocation for PSCCH is based on interlaced based resource pool, when the interlace based resource allocation at least for PSCCH is (pre-)configured to be enabled.

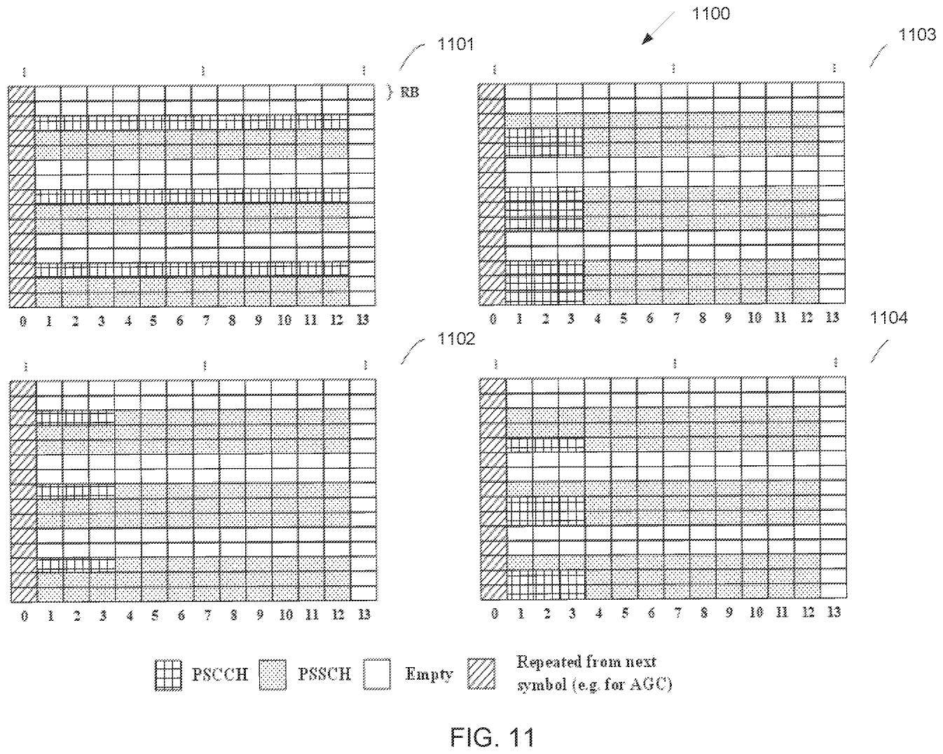

For one example, the time domain information for the resource allocation for PSCCH can be all sidelink symbols in the slot, other than the AGC symbol (e.g., repetition symbol before PSSCH or PSFCH), guard symbol(s), and PSFCH symbols if configured in the slot, can be allocated for PSCCH, as shown in 1101 of FIG. 11. For this example, the UE assumes the (pre-)configured set of interlace index(ices) for PSCCH and the interlace index(ices) in the sub-channel(s) for PSSCH do not overlap.

For another example, the time domain information for the resource allocation for PSCCH can be provided by a pre-configuration or configured by higher layer parameters, as shown in 1102 of FIG. 11. For this sub-example, the interlace index(ices) (pre-)configured for PSCCH can be a subset of interlace index(ices) in the sub-channel(s) for PSSCH.

For one example, the frequency domain information for the resource allocation for PSCCH can be an indication of a set of interlace indices. For one particular instance, the number of the interlace indices is one, and one interlace in the (pre-)configured sub-channel(s) in the interlace based resource pool is (pre-)configured for PSCCH. For instance, the indication of the set of interlace indices (or the single interlace index) can be provided by a pre-configuration or configured by a higher layer parameter, e.g., associated with the configuration of the resource pool.

For another example, the frequency domain information for the resource allocation for PSCCH can be a fixed set of interlace(s) within the interlace index(ices) in the sub-channel(s) (pre-)configured for PSSCH.

For one sub-example, the number of interlace for PSCCH can be 1, and it is fixed as the interlace with the lowest index within the set of interlaces in the sub-channel(s) for PSSCH.

For another sub-example, the number of interlace for PSCCH can be 1, and it is fixed as the interlace that its lowest RB overlaps with the lowest RB for PSSCH.

For yet another example, the frequency domain information for the resource allocation for PSCCH can be an indication of a number of RBs. For instance, the indication can be provided by a pre-configuration or configured by higher layer parameters.

For one sub-example, RBs for resource allocation for PSCCH are the ones with the lowest indices (up to the (pre-)configured number of RBs) within all the RBs in the set of interlaces corresponding to the (pre-)configured sub-channels for PSSCH (e.g., the RBs are selected from the lowest to highest RBs within all the RBs in the set of interlaces corresponding to the (pre-)configured sub-channels for PSSCH until the (pre-)configured number of RBs for PSCCH is achieved). For instance, the RBs can belong to multiple interlaces. This sub-example is shown in 1103 of FIG. 11.

FIG. 11 illustrates an example of resource allocation for PSCCH 1100 according to various embodiments of the present disclosure. An embodiment of the resource allocation for PSCCH 1100 shown in FIG. 11 is for illustration only.

For another sub-example, RBs for resource allocation for PSCCH are selected in the order of lowest to highest RB within the first interlace in the (pre-)configured set of interlaces for PSSCH or in the resource pool, and then in the order of lowest to highest interlace in the set of interlaces corresponding to the sub-channel(s) (pre-)configured for PSSCH or in the resource pool, until the (pre-)configured number of RBs for PSCCH is achieved. If there is a further restriction that the (pre-)configured number of RBs for PSCCH is no larger than the number of RBs in an interlace, then the RBs for resource allocation for PSCCH are selected in the order of lowest to highest RB within the first interlace in the (pre-)configured set of interlaces for PSSCH until the (pre-)configured number of RBs is achieved. This sub-example is shown in 1104 of FIG. 11.

For yet another sub-example, RBs for resource allocation for PSCCH are selected in the order of lowest to highest RB within the first sub-channel in the (pre-)configured set of sub-channel(s) for PSSCH or in the resource pool, and then in the order of lowest to highest sub-channel in the (pre-)configured set of sub-channel(s) for PSSCH or in the resource pool, until the (pre-)configured number of RBs for PSCCH is achieved. If there is a further restriction that the (pre-)configured number of RBs for PSCCH is no larger than the number of RBs in a sub-channel, then the RBs for resource allocation for PSCCH are selected in the order of lowest to highest RB within the lowest sub-channel in the (pre-)configured set of sub-channel(s) for PSSCH until the (pre-)configured number of RBs is achieved.

For yet another example, the frequency domain information for the resource allocation for PSSCH can be an indication of a number of RBs and a set of interlace/sub-channel indices (including a single interlace).

For one sub-example, RBs for resource allocation for PSCCH are the ones with the lowest indices (up to the (pre-)configured number of RBs) within all the RBs in the (pre-)configured set of interlaces for PSCCH. For instance, the RBs can belong to multiple interlaces.

For another sub-example, RBs for resource allocation for PSCCH are selected in the order of lowest to highest RB within the first interlace in the (pre-)configured set of interlaces, and then in the order of interlace in the (pre-)configured set of interlaces for PSCCH, and so on until the (pre-)configured number of RBs is achieved. If there is a further restriction that the (pre-)configured number of RBs for PSCCH is no larger than the number of RBs in an interlace, then the RBs for resource allocation for PSCCH are selected in the order of lowest to highest RB within the single interlace (pre-)configured for PSCCH until the (pre-)configured number of RBs is achieved.

In one embodiment, a subset of resource allocated for PSSCH can be used for transmitting the 2nd-stage SCI format, e.g., including at least one of the SCI format 2-A or 2-B or 2-C.

In one example, the frequency domain information for the resource allocation for PSSCH carrying the 2nd-stage SCI format can be an indication of a set of interlace indices, wherein the set of interlace indices is a subset of interlace indices corresponding to the sub-channel(s) (pre-)configured for PSSCH.

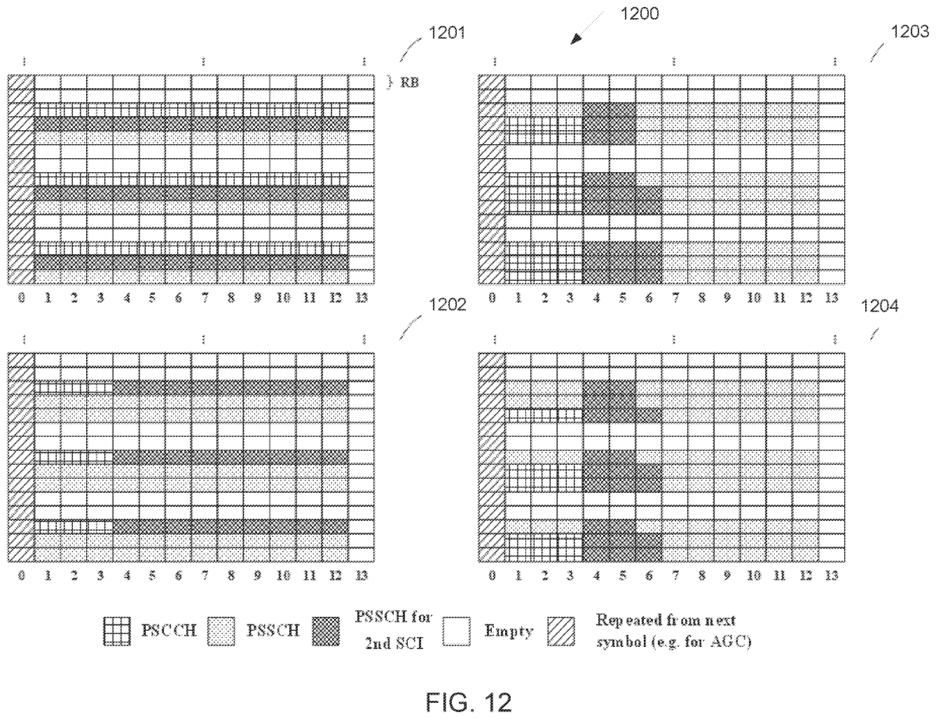

FIG. 12 illustrates an example of resource allocation for PSFCH 1200 according to various embodiments of the present disclosure. An embodiment of the resource allocation for PSFCH 1200 shown in FIG. 12 is for illustration only.

For one sub-example, there is no time domain restriction on the PSSCH carrying the 2nd-stage SCI format, which means all the sidelink symbols for PSSCH are available for transmitting PSSCH carrying the 2nd-stage SCI format, and the interlace(s) for PSSCH carrying the 2nd-stage SCI format does not overlap with the interlace(s) for PSCCH, as shown in 1201 of FIG. 12.

For another sub-example, there is no time domain restriction on the PSSCH carrying the 2nd-stage SCI format, which means all the sidelink symbols for PSSCH are available for transmitting PSSCH carrying the 2nd-stage SCI format, and the interlace(s) for PSSCH carrying the 2nd-stage SCI format can overlap with the interlace(s) for PSCCH, wherein PSSCH carrying the 2nd-stage SCI format is mapped to the remaining symbols other than those mapped for PSCCH, in the overlapped RBs, as shown in 1202 of FIG. 12.

In another example, the frequency domain information for the resource allocation for PSSCH carrying the 2nd-stage SCI format can be an indication of a scaling factor, and the UE can determine the number of RBs for PSSCH carrying the 2nd-stage SCI format based on the scaling factor. For instance, the indication of the scaling factor is provided by the 1st-stage SCI format.

In one sub-example, the RBs for PSSCH carrying the 2nd-stage SCI format are selected first in the order of lowest RB to the highest RB within all RBs in the (pre-)configured interlace(s) or sub-channel(s) for PSSCH, and then in the order of lowest symbol index to highest symbol index within a set of symbols in the slot. For instance, the set of symbols in the slot are with the restriction that the first symbol is the next symbol after the last symbol of PSCCH, or the first symbol is the first symbol including DM-RS of PSSCH. The UE assumes REs for at least one of DM-RS, PSCCH and PT-RS are not available for PSSCH carrying the 2nd-stage SCI format. This sub-example is shown in 1203 of FIG. 12.

In another sub-example, the RBs for PSSCH carrying the 2nd-stage SCI format are selected first in the order of lowest RB to the highest RB within one interlace, and then lowest interlace to highest interlace in the (pre-)configured interlace(s) for PSSCH, and then in the order of lowest symbol index to highest symbol index within a set of symbols in the slot. For instance, the set of symbols in the slot are with the restriction that the first symbol is the next symbol after the last symbol of PSCCH or the first symbol is the first symbol including DM-RS of PSSCH. The UE assumes REs for at least one of DM-RS, PSCCH and PT-RS are not available for PSSCH carrying the 2nd-stage SCI format. This sub-example is shown in 1204 of FIG. 12.

In yet another sub-example, the RBs for PSSCH carrying the 2nd-stage SCI format are selected first in the order of lowest RB to the highest RB within one sub-channel, and then lowest interlace to highest sub-channel in the (pre-)configured sub-channel(s) for PSSCH, and then in the order of lowest symbol index to highest symbol index within a set of symbols in the slot. For instance, the set of symbols in the slot are with the restriction that the first symbol is the next symbol after the last symbol of PSCCH or the first symbol is the first symbol including DM-RS of PSSCH. The UE assumes REs for at least one of DM-RS, PSCCH and PT-RS are not available for PSSCH carrying the 2nd-stage SCI format. This sub-example is shown in 1204 of FIG. 12.

In yet another sub-example, the RBs for PSSCH carrying the 2nd-stage SCI format are selected first in the order of lowest symbol index to highest symbol index with the restriction that the first symbol is the next symbol after the last symbol of PSCCH or the first symbol is the first symbol including DM-RS of PSSCH, and then in the order of lowest RB to the highest RB within all RBs in the (pre-)configured interlace(s) for PSSCH. The UE assumes REs for at least one of DM-RS, PSCCH and PT-RS are not available for PSSCH carrying the 2nd-stage SCI format.

In one sub-example, the RBs for PSSCH carrying the 2nd-stage SCI format are selected first in the order of lowest symbol index to highest symbol index with the restriction that the first symbol is the next symbol after the last symbol of PSCCH or the first symbol is the first symbol including DM-RS of PSSCH, and then in the order of lowest RB to the highest RB within all RBs in the (pre-)configured interlace for PSSCH, and then lowest interlace to highest interlace in the (pre-)configured interlace(s) for PSSCH. The UE assumes REs for at least one of DM-RS, PSCCH and PT-RS are not available for PSSCH carrying the 2nd-stage SCI format.

In one sub-example, the RBs for PSSCH carrying the 2nd-stage SCI format are selected first in the order of lowest symbol index to highest symbol index with the restriction that the first symbol is the next symbol after the last symbol of PSCCH or the first symbol is the first symbol including DM-RS of PSSCH, and then in the order of lowest RB to the highest RB within all RBs in the (pre-)configured sub-channel for PSSCH, and then lowest interlace to highest sub-channel in the (pre-)configured sub-channel(s) for PSSCH. The UE assumes REs for at least one of DM-RS, PSCCH and PT-RS are not available for PSSCH carrying the 2nd-stage SCI format.

In another embodiment, the coded bits for the 2nd-stage SCI format are multiplexed with the codes bits for the other information in PSSCH to construct one single bit stream, and then the single bit stream is mapped to resource elements in RBs in the interlace(s) corresponding to the sub-channel(s) (pre-)configured for PSSCH.

In one embodiment, the transmission and reception of PSFCH can be based on the interlace based resource pool.

In one example, the frequency domain unit for transmission and reception of PSFCH is an interlace.

In another example, the frequency domain unit for transmission and reception of PSFCH is a sub-channel.

In another example, a UE can be provided a bitmap indicating a set of interlaces in a resource pool for PSFCH transmission in one interlace of the resource pool. For instance, the length of the bitmap equals to the number of interlaces (pre-)configured for the resource pool.

In yet another example, a UE can be provided a bitmap indicating a set of sub-channels in a resource pool for PSFCH transmission in one interlace of the resource pool. For instance, the length of the bitmap equals to the number of sub-channels (pre-)configured for the resource pool.

In yet another example, the UE can determine one interlace from the set of interlaces in the resource pool for transmitting PSFCH based on the bitmap and identity of the UE.

In yet another example, a UE can be provided a bitmap indicating a set of sub-channel(s) in a resource pool for PSFCH transmission in one sub-channel of the resource pool. For instance, the length of the bitmap equals to the number of sub-channel(s) (pre-)configured for the resource pool.

In yet another example, there is a cyclic shift hopping in different RBs of an interlace, e.g., for PSFCH format 0, the term mᵢₙₜ in the cyclic shift aₗ can be given by mᵢₙₜ=c₁+c₂ n_{IRB}^{μ}, wherein n_{IRB}^{μ} is the RB index within the interlace. For one instance, c₁ and c₂ are pre-configured or configured by higher layer parameters. For another instance, c₁=0 and c₂ is pre-configured or configured by higher layer parameter. For yet another instance, c₁ and c₂ are fixed integers, such as c₁=0 and c₂=5; or c₁=2 and c₂=5; or c₁=3 and c₂=5; or c₁=0 and c₂=7.

In yet another example, the mapping of sequence for PSFCH format 0 to resource elements can be repeated for each resource block in the interlace and in the active bandwidth part over the assigned physical resource blocks with the resource block dependent sequence.

FIG. 13 illustrates an example method 1300 for the UE determine an interlace based resource pool for SL communication according to embodiments of the present disclosure. The steps of the method 1300 of FIG. 13 can be performed by any of the UEs 111-116 of FIG. 1, such as the UE 116 of FIG. 3. The method 1300 is for illustration only and other embodiments can be used without departing from the scope of the present disclosure.

The method 1300 begins with the UE receiving a set of configurations (1310). For example, in step 1310, the UE may receive the configurations from a BS or another UE. The UE then determines a resource pool including a set of sub-channels (1320). For example, in step 1320, the UE determines the resource pool using the set of configurations. Here, the sub-channel in the set of sub-channels each include a set of interlaces of RBs and the interlaces in the set of interlaces each include RBs with a uniform interval of M RBs. In various embodiments, the uniform interval M for the interlace is determined based on a SCS of the RBs, where M=10, when the SCS of the RBs is 15 kHz and M=5, when the SCS of the RBs is 30 kHz. In various embodiments, the set of interlaces of RBs in the sub-channel is contiguous in a frequency domain. In various embodiments, the set of sub-channels in the resource pool is contiguous in a frequency domain.

The UE then determines a set of resources within the resource pool allocated for a PSCCH or PSFCH (1330). For example, in step 1330, the set of resources within the resource pool allocated for the PSCCH includes a set of RBs and the set of RBs are selected from the resource pool in an order of first a lowest RB to a highest RB within a sub-channel and then in an order of a lowest sub-channel to a highest sub-channel within the resource pool. In various embodiments, the set of resources within the resource pool allocated for the PSFCH includes an interlace of RBs and wherein the interlace of RBs is selected from the set of interlaces included in the resource pool. In various embodiments, the set of resources within the resource pool allocated for the PSFCH includes an interlace of RBs and the interlace of RBs is selected from the set of interlaces included in the resource pool. For example, a sequence is generated for each RB within the interlace of RBs where the sequence is associated with a cyclic shift. The cyclic shift is generated based on an index of the RBs within the interlace of RBs.

The UE then transmits the PSCCH or PSFCH using the determined set of resources (1340). For example, in step 1340, the UE transmits the PSCCH or PSFCH to another UE, such as UE 111a in FIG. 1, using SL communication. The UE may transmit both the PSCCH and PSFCH using one or more of the resources in the determined set.

In various embodiments, the UE may receive a first stage SCI format that includes an indication of a set of resources allocated for a PSSCH or a second stage SCI format. In one example, the set of resources allocated for the PSSCH includes a set of sub-channels included in the resource pool and the sub-channels in the set of sub-channels are contiguous. In another example, the set of resources allocated for the second stage SCI format includes a set of RBs, and the set of RBs are selected from the resource pool in an order of (i) first a lowest RB to a highest RB within a sub-channel, then in an order of a lowest sub-channel to a highest sub-channel within the resource pool, and then in an order of a lowest symbol to a highest symbol within a slot.

The above flowcharts and signaling flow diagrams illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of configurations; and
a processor operably coupled to the transceiver, the processor configured to:
determine, from the set of configurations, a resource pool including a set of sub-channels, a sub-channel in the set of sub-channels including a set of interlaces of resource blocks (RBs), wherein an interlace in the set of interlaces includes RBs with a uniform interval of M RBs;
determine a set of resources within the resource pool allocated for a physical sidelink control channel (PSCCH) or a physical sidelink feedback channel (PSFCH),
wherein the transceiver further configured to transmit, to another UE, the PSCCH or PSFCH based on the determined set of resources.

2. The UE of claim 1, wherein:
the uniform interval M for the interlace is determined based on a subcarrier spacing (SCS) of the RBs,
M=10, when the SCS of the RBs is 15 kilohertz (kHz), and
M=5, when the SCS of the RBs is 30 kilohertz (kHz).

3. The UE of claim 1, wherein the set of interlaces of RBs in the sub-channel are contiguous in a frequency domain.

4. The UE of claim 1, wherein the set of sub-channels in the resource pool are contiguous in a frequency domain.

5. The UE of claim 1, wherein:
the set of resources within the resource pool allocated for the PSCCH includes a set of RBs, and
the set of RBs are selected from the resource pool in an order of (i) first a lowest RB to a highest RB within a sub-channel and (ii) then a lowest sub-channel to a highest sub-channel within the resource pool.

6. The UE of claim 1, wherein the set of resources within the resource pool allocated for the PSFCH includes an interlace of RBs and wherein the interlace of RBs is selected from the set of interlaces included in the resource pool.

7. The UE of claim 6, wherein:
a sequence is generated for each RB within the interlace of RBs,
the sequence is associated with a cyclic shift, and
the cyclic shift is generated based on an index of the each RB within the interlace of RBs.

8. The UE of claim 1, wherein:
the transceiver is further configured to receive a first stage sidelink control information (SCI) format, and
the first stage SCI format includes an indication of a set of resources allocated for a physical sidelink shared channel (PSSCH) or a second stage SCI format.

9. The UE of claim 8, wherein:
the set of resources allocated for the PSSCH includes a set of sub-channels included in the resource pool, and
the sub-channels in the set of sub-channels are contiguous.

10. The UE of claim 8, wherein:
the set of resources allocated for the second stage SCI format includes a set of RBs, and
the set of RBs are selected from the resource pool in an order of (i) first a lowest RB to a highest RB within a sub-channel, (ii) then a lowest sub-channel to a highest sub-channel within the resource pool, and (iii) then a lowest symbol to a highest symbol within a slot.

11. A method of a user equipment (UE) in a wireless communication system, the method comprising:
receiving a set of configurations;
determining, from the set of configurations, a resource pool including a set of sub-channels, a sub-channel in the set of sub-channels including a set of interlaces of resource blocks (RBs), wherein an interlace in the set of interlaces includes RBs with a uniform interval of M RBs;
determining a set of resources within the resource pool allocated for a physical sidelink control channel (PSCCH) or a physical sidelink feedback channel (PSFCH); and
transmitting, to another UE, the PSCCH or PSFCH based on the determined set of resources.

12. The method of claim 11, wherein:
the uniform interval M for the interlace is determined based on a subcarrier spacing (SCS) of the RBs,
M=10, when the SCS of the RBs is 15 kilohertz (kHz), and
M=5, when the SCS of the RBs is 30 kilohertz (kHz).

13. The method of claim 11, wherein the set of interlaces of RBs in the sub-channel are contiguous in a frequency domain.

14. The method of claim 11, wherein the set of sub-channels in the resource pool are contiguous in a frequency domain.

15. The method of claim 11, wherein:
the set of resources within the resource pool allocated for the PSCCH includes a set of RBs, and
the set of RBs are selected from the resource pool in an order of (i) first a lowest RB to a highest RB within a sub-channel and (ii) then in an order of a lowest sub-channel to a highest sub-channel within the resource pool.

16. The method of claim 11, wherein the set of resources within the resource pool allocated for the PSFCH includes an interlace of RBs and wherein the interlace of RBs is selected from the set of interlaces included in the resource pool.

17. The method of claim 16, wherein:
a sequence is generated for each RB within the interlace of RBs,
the sequence is associated with a cyclic shift, and
the cyclic shift is generated based on an index of the each RB within the interlace of RBs.

18. The method of claim 11 further comprising:
receiving a first stage sidelink control information (SCI) format,
wherein the first stage SCI format includes an indication of a set of resources allocated for a physical sidelink shared channel (PSSCH) or a second stage SCI format.

19. The method of claim 18, wherein:
the set of resources allocated for the PSSCH includes a set of sub-channels included in the resource pool, and
the sub-channels in the set of sub-channels are contiguous.

20. The method of claim 18, wherein:
the set of resources allocated for the second stage SCI format includes a set of RBs, and
the set of RBs are selected from the resource pool in an order of (i) first a lowest RB to a highest RB within a sub-channel, (ii) then in an order of a lowest sub-channel to a highest sub-channel within the resource pool, and (iii) then in an order of a lowest symbol to a highest symbol within a slot.
